(19) United States
(12) Patent Application Publication
(10) Pub. No.: US 2024/0011333 A1
(43) Pub. Date: Jan. 11, 2024

(54) RETAINING A CLOSED STATE OF AN INFORMATION HANDLING SYSTEM

(71) Applicant: Dell Products L.P., Round Rock, TX (US)

(72) Inventors: Cheng-Chih Lee, New Taipei City (TW); Hsin-Hung Hsiao, Taipei City (TW)

(21) Appl. No.: 17/811,142

(22) Filed: Jul. 7, 2022

(51) Int. Cl. E05B 73/00; E05B 47/00; G01C 9/06

(52) U.S. Cl. CPC E05B 73/0082; E05B 47/0006; G01C 9/06; E05B 2047/0067

(57) ABSTRACT

Retaining a closed state of an information handling system, including: determining that the information handling system is in a closed state; in response to determining that the information handling system is in the closed state: calculating a tilt of the information handling system; calculating linear motion of the information handling system; determining whether the tilt of the information handling system is greater than a tilt threshold and determining whether the linear motion of the information handling system is greater than a linear motion threshold; and in response to determining that at least one of i) the tilt of the information handling system being greater than the tilt threshold and ii) the linear motion of the information handling system being greater than the linear motion threshold: adjusting a magnetic force of an electromagnet to retain the closed state of the information handling system.

### BACKGROUND

### Field of the Disclosure

The disclosure relates generally to an information handling system, and in particular, retaining a closed state of an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

Innovative aspects of the subject matter described in this specification may be embodied in a method of retaining a closed state of an information handling system, including determining that the information handling system is in a closed state; in response to determining that the information handling system is in the closed state: calculating a tilt of the information handling system; calculating linear motion of the information handling system; determining whether the tilt of the information handling system is greater than a tilt threshold and determining whether the linear motion of the information handling system is greater than a linear motion threshold; and in response to determining that at least one of i) the tilt of the information handling system being greater than the tilt threshold and ii) the linear motion of the information handling system being greater than the linear motion threshold: adjusting a magnetic force of an electromagnet to retain the closed state of the information handling system.

Other embodiments of these aspects include corresponding systems, apparatus, and computer programs, configured to perform the actions of the methods, encoded on computer storage devices.

These and other embodiments may each optionally include one or more of the following features. For instance, determining that the information handling system is in the closed state further includes: calculating an angle between a first body and a second body of the information handling system; and determining that the angle is zero degrees indicating the closed state of the information handling system. Adjusting the magnetic force of the electromagnetic further includes adjusting an electric current at the electromagnet. Determining that both i) the tilt of the information handling system is greater than the tilt threshold and ii) the linear motion of the information handling system is greater than the linear motion threshold, and in response, adjusting the magnetic force of the electromagnet to retain the closed state of the information handling system. Determining that i) the tilt of the information handling system is less than the tilt threshold and ii) the linear motion of the information handling system is less than the linear motion threshold, and in response, decreasing the magnetic force of the electromagnet. Determining that the angle is greater than zero degrees, and in response, decreasing the magnetic force of the electromagnet. The tilt threshold is approximately 70 degrees.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a perspective view of the information handling system in an open state.

FIG. 3 illustrates a block diagram of the information handling system.

FIG. 4 illustrates a method for retaining the closed state of the information handling system.

FIG. 5 illustrates a perspective view of the information handling system in a closed state.

FIG. 6 illustrates a block diagram of a tilted state of the information handling system.

### DESCRIPTION OF PARTICULAR EMBODIMENT(S)

This disclosure discusses methods and systems for retaining a closed state of an information handling system. In short, an electromagnet management computing module can receive sensor data from sensors (e.g., accelerometers) of the information handling system. The sensor data can indicate a system angle, lid angle, and linear motion of the information handling system. The electromagnet management computing module, based on the sensor data, can adjust an electromagnetic force applied by an electromagnet of the information handling system to retain the information handling system in a closed state, when appropriate.

Specifically, this disclosure discusses a system and a method for retaining a closed state of an information handling system, including determining that the information handling system is in a closed state; in response to determining that the information handling system is in the closed state: calculating a tilt of the information handling system; calculating linear motion of the information handling system; determining whether the tilt of the information handling system is greater than a tilt threshold and determining whether the linear motion of the information handling system is greater than a linear motion threshold; and in response to determining that at least one of i) the tilt of the information handling system being greater than the tilt threshold and ii) the linear motion of the information handling system being greater than the linear motion threshold: adjusting a magnetic force of an electromagnet to retain the closed state of the information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

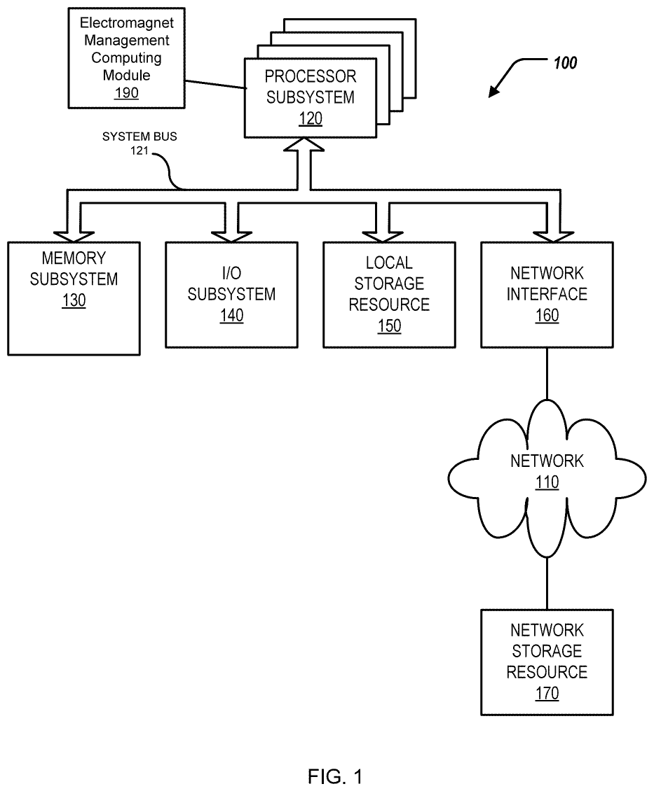

Particular embodiments are best understood by reference to FIGS. 1-6 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, or a camera, or another type of peripheral device.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g. corporate) network. The network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g. customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include an electromagnet management computing module 190. The electromagnet management computing module 190 can be associated with and/or executed by the processor subsystem 120.

In short, the electromagnet management computing module 190 can receive sensor data from sensors (e.g., accelerometers) of the information handling system 100. The sensor data can indicate a system angle, lid angle, and linear motion of the information handling system 100. The electromagnet management computing module 190, based on the sensor data, can adjust an electromagnetic force applied by an electromagnet of the information handling system to retain the information handling system 202 in a closed state, when appropriate.

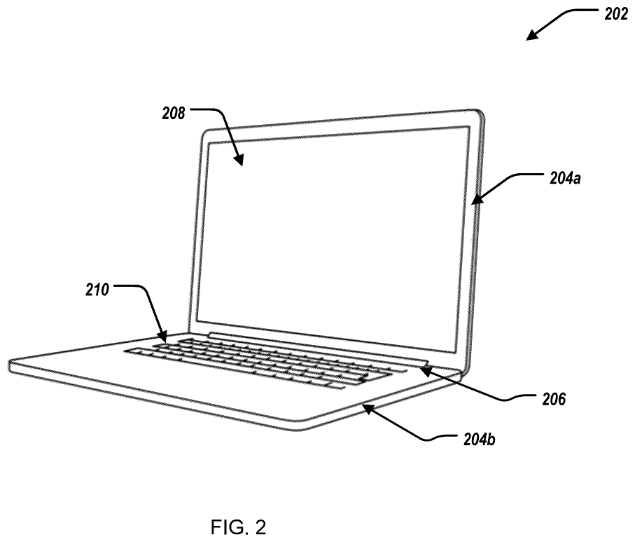

Turning to FIG. 2, FIG. 2 illustrates a perspective view of the information handling system 202. The information handling system 202 can include a first body 204a and a second body 204b (collectively referred to as bodies 204) connected by a hinge 206. In general, the first body 204a can include a display 208, and the second body 204b can include a keyboard 209.

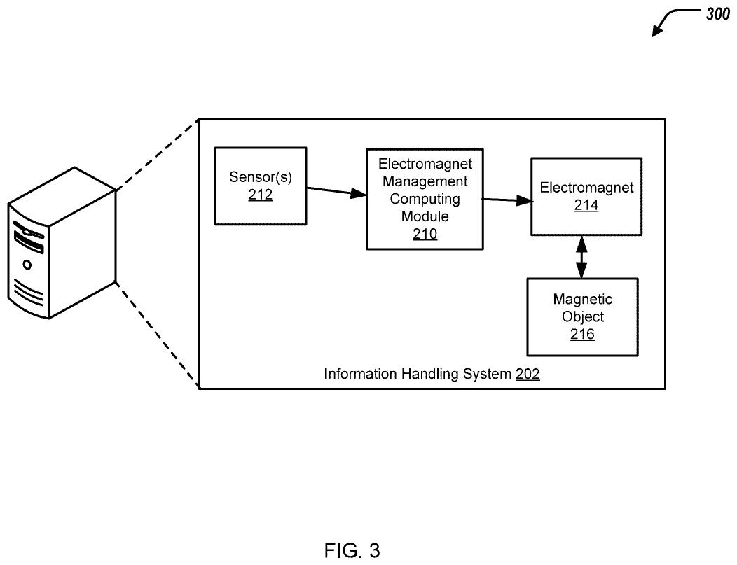

FIG. 3 illustrates a block diagram of the information handling system 202. The information handling system 202 can include an electromagnet management computing module 210, sensor(s) 212, an electromagnet 214, and a magnetic object 216.

In some examples, the information handling system 202 is similar to, or includes, the information handling system 100 of FIG. 1. In some examples, the electromagnet (EM) management computing module 210 is the same, or substantially the same, as the electromagnet management computing module 190 of FIG. 1.

The EM management computing module 210 can be in communication with the sensors 212 and the electromagnet 214.

In some examples, the sensors 212 can include accelerometers. In some examples, at least one sensor 212 is positioned within the first body 204a and at least one other sensor 212 is positioned within the second body 204b.

The sensors 212 can provide sensor data associated with the information handling system 202 to the EM management computing module 210. The EM management computing module 210 can receive the sensor data from the sensors 212 continuously, or at predetermined intervals. The sensor data can include an angle of the information handling system 202 (e.g., with respect to the horizon or “horizontal”); an angle between each of the bodies 204 of the information handling system 202; and linear motion of the information handling system 202, described further below.

The electromagnet 214 and the magnetic object 216 can each be positioned in differing bodies 204 of the information handling system 202. For example, the electromagnet 214 can be contained within the second body 204b and the magnetic object 216 can be contained within the first body 204a. The electromagnet 214 can provide magnetic forces to attract the magnetic object 216.

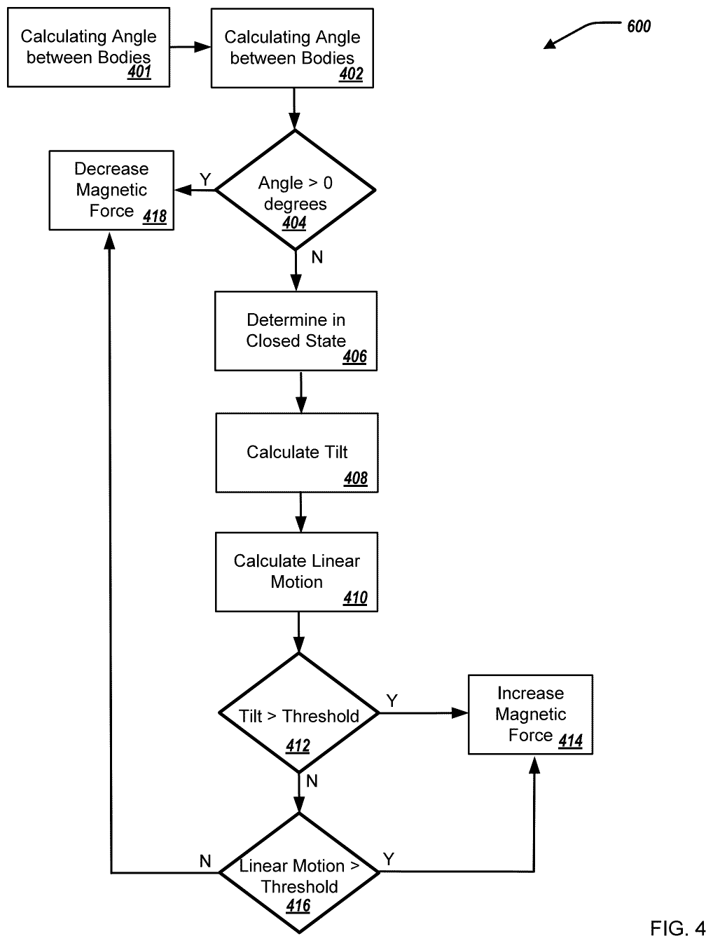

FIG. 4 illustrates a flowchart depicting selected elements of an embodiment of a method 400 for retaining (or maintaining) the closed state of the information handling system 202. The method 400 may be performed by the information handling system 100, the information handling system 202, the sensors 212, the EM management computing module 210, and/or the electromagnet 214, and with reference to FIGS. 1-3, 5, and 6. It is noted that certain operations described in method 400 may be optional or may be rearranged in different embodiments.

The EM management computing module 210 receives sensor data from the sensors 212, at 401. The sensor data can include data associated with an angle of the information handling system 202 (e.g., with respect to the horizon or “horizontal”); an angle between each of the bodies 204 of the information handling system 202; and linear motion of the information handling system 202

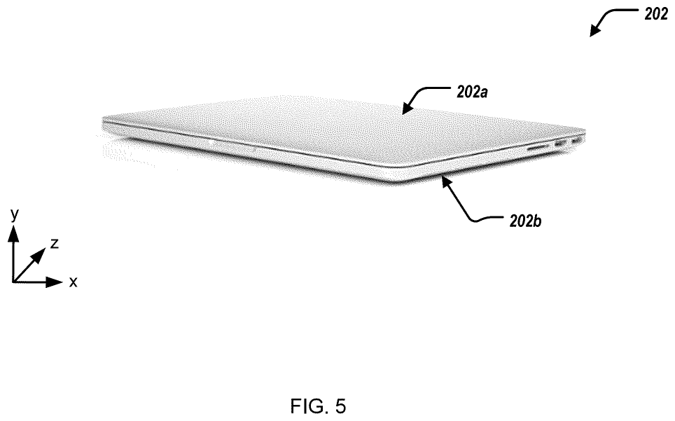

The EM management computing module 210 calculates an angle between the first body 204a and the second body 204b of the information handling system 202, at 402. The EM management computing module 210 determines whether the angle between the first body 204a and the second body 204b is greater than zero degrees, at 404. That is, the EM management computing module 210, based on the sensor data provided by the sensors 212, determines whether the angle between the first body 204a and the second body 204b is greater than zero degrees. In some examples, the EM management computing module 210 determines that the angle between the first body 204a and the second body 204b is not greater than zero degrees (i.e., the angle between the first body 204a and the second body 204b is zero degrees). When the angle between the first body 204a and the second body 204b is not greater than zero degrees, the EM management computing module 210 determines that the information handling system 202 is in a closed state, at 406. FIG. 5 illustrates a perspective view of the information handling system 202 in the closed state. That is, the angle between the first body 204a and the second body 204b is zero degrees.

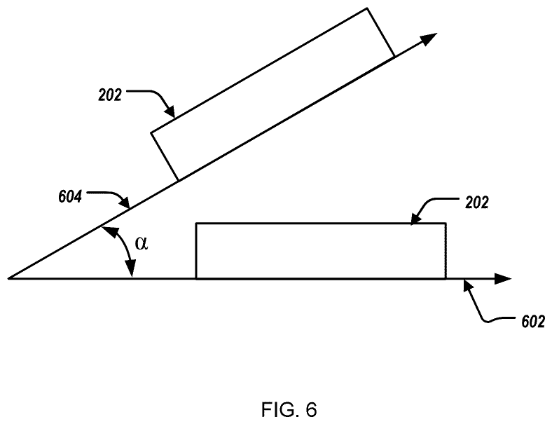

The EM management computing module 210, in response to determining that the information handling system 202 is in the closed state (at 406), calculates a tilt of the information handling system 202, at 408. That is, the EM management computing module 210 calculates, based on the sensor data received from the sensors 212, the tilt of the information handling system 202. For example, the EM management computing module 210 calculates the tilt of the information handling system 202 with respect to the “horizontal” or horizon. FIG. 6 illustrates a block diagram of the information handling system 202 in a tilted state. Specifically, initially, the information handling system 202 can be in horizontal state, and positioned along a horizontal plane 602. The information handling system 202 can be placed in the tilted state, and positioned along a tilted plane 604. The tilted plane 604 can be angled with respect to the horizontal plane 602 by an angle α. The EM management computing module 210 calculates, based on the sensor data received from the sensors 212, the tilt of the information handling system 202, and specifically, calculates the angle α. In some examples, the information handling system 202 can be placed in the tilted state when the information handling system 202 is carried by a user from one place to another.

The EM management computing module 210, further in response to determining that the information handling system 202 is in the closed state (at 406), calculates a linear motion of the information handling system, at 410. That is, the EM management computing module 210 calculates, based on the sensor data received from the sensors 212, the linear motion of the information handling system 202. For example, the EM management computing module 210 calculate a vibration (linear motion) of the information handling system 202 along the X, Y, and Z direction, shown in FIG. 5. That is, the EM management computing module 210 can vibrate (linear motion) along the X, Y, and Z direction, and the EM management computing module 210 can calculate (quantify) the magnitude (e.g., gravitational “g”-forces) of the vibration (linear motion). In some examples, the information handling system 202 can experience linear motion when being carried by a user, or placed in moving vehicle.

The EM management computing module 210 can compare the magnitude of the tilt with a tilt threshold, at 412. That is, the EM management computing module 210 can compare the angle α of the first body 204a with respect to the second body 204b with a tilt threshold. In some examples, the tilt threshold is approximately 70 degrees.

In some examples, the EM management computing module 210 determines that the tilt of the information handling system 202 is greater than the tilt threshold (at 412). In response to determining that the tilt (angle α) of the information handling system 202 is greater than the tilt threshold, the EM management computing module 210 adjusts the magnetic force of the electromagnet 214 to retain the closed state of the information handling system 202, at 414. That is, when the tilt of the information handling system 202 is greater than the tilt threshold and the information handling system 202 is in the closed state, the EM management computing module 210 adjusts the magnetic force of the electromagnet 214 to retain the closed state of the information handling system 202. Specifically, the EM management computing module 210 increases the magnetic force of the electromagnet 214 by adjusting (increasing) the electric current at the electromagnet 214. As such, the magnetic force of the electromagnet 214 is increased (by the increased electric current at the electromagnet 214) that attracts the magnetic object 216, thus, retaining (maintaining) the closed state of the information handling system.

In some examples, the EM management computing module 210 determines that the tilt of the information handling system 202 is less than the tilt threshold (at 412). In response to determining that the tilt (angle α) of the information handling system 202 is less than the tilt threshold, the EM management computing module 210 compare the linear motion of the information handling system 202 with a motion linear threshold, at 416. For example, the linear motion threshold can be a gravitational force magnitude (“g-forces”).

In some examples, the EM management computing module 210 determines that the linear motion of the information handling system 202 is greater than the linear motion threshold (at 416). In response to determining that the linear motion of the information handling system 202 is greater than the linear motion threshold, the EM management computing 210 adjusts the magnetic force of the electromagnet 214 to retain the closed state of the information handling system 202, at 414. That is, when the linear motion of the information handling system 202 is greater than the linear motion threshold and the information handling system 202 is in the closed state, the EM management computing module 210 adjusts the magnetic force of the electromagnet 214 to retain the closed state of the information handling system 202. Specifically, the EM management computing module 210 increases the magnetic force of the electromagnet 214 by adjusting (increasing) the electric current at the electromagnet 214. As such, the magnetic force of the electromagnet 214 is increased (by the increased electric current at the electromagnet 214) that attracts the magnetic object 216, thus, retaining (maintaining) the closed state of the information handling system.

In some examples, the EM management computing module 210 determines that the linear motion of the information handling system 202 is less than the linear motion threshold (at 416). In response to determining that the linear motion of the information handling system 202 is less than the linear motion threshold, the EM management computing 210 decreases the magnetic force of the electromagnet 214, at 418. That is, when the linear motion of the information handling system 202 is less than the linear motion threshold and the information handling system 202 is in the closed state, the EM management computing module 210 decreases the magnetic force of the electromagnet 214 (e.g., to conserve power at the information handling system 202). In some examples, the EM management computing module 210 ceases providing current to the electromagnet 214 to cease the magnetic force at the electromagnet 214.

In some examples, the EM management computing module 210 determines that the linear motion of the information handling system 202 is greater than the linear motion threshold, and determines that the tilt of the information handling system 202 is greater than the tilt threshold. That is, when the linear motion of the information handling system 202 is greater than the linear motion threshold, the tilt of the information handling system 202 is greater than the tilt threshold, and the information handling system 202 is in the closed state, the EM management computing module 210 adjusts the magnetic force of the electromagnet 214 to retain the closed state of the information handling system 202. Specifically, the EM management computing module 210 increases the magnetic force of the electromagnet 214 by adjusting (increasing) the electric current at the electromagnet 214. As such, the magnetic force of the electromagnet 214 is increased (by the increased electric current at the electromagnet 214) that attracts the magnetic object 216, thus, retaining (maintaining) the closed state of the information handling system.

In some examples, the EM management computing module 210 determines that the angle between the first body 204a and the second body 204b is greater than zero degrees (i.e., the angle between the first body 204a and the second body 204b is greater than zero degrees). When the angle between the first body 204a and the second body 204b is greater than zero degrees, the EM management computing module 210 determines that the information handling system 202 is in an open state, and decreases the magnetic force of the electromagnet 214, at 418. That is when the information handling system 202 is in the open state, the EM management computing module 210 decreases the magnetic force of the electromagnet 214 (e.g., to conserve power at the information handling system 202). In some examples, the EM management computing module 210 ceases providing current to the electromagnet 214 to cease the magnetic force at the electromagnet 214. FIG. 3 illustrates a perspective view of the information handling system 202 in the open state. That is, the angle between the first body 204a and the second body 204b is greater than zero degrees.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated other-wise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method of retaining a closed state of an information handling system, the method comprising:
determining that the information handling system is in a closed state;
in response to determining that the information handling system is in the closed state:
calculating a tilt of the information handling system;
calculating linear motion of the information handling system;
determining whether the tilt of the information handling system is greater than a tilt threshold and determining whether the linear motion of the information handling system is greater than a linear motion threshold; and
in response to determining that at least one of i) the tilt of the information handling system being greater than the tilt threshold and ii) the linear motion of the information handling system being greater than the linear motion threshold:
adjusting a magnetic force of an electromagnet to retain the closed state of the information handling system.

2. The method of claim 1, wherein determining that the information handling system is in the closed state further includes:
calculating an angle between a first body and a second body of the information handling system; and
determining that the angle is zero degrees indicating the closed state of the information handling system.

3. The method of claim 1, wherein adjusting the magnetic force of the electromagnetic further includes adjusting an electric current at the electromagnet.

4. The method of claim 1, further comprising:
determining that both i) the tilt of the information handling system is greater than the tilt threshold and ii) the linear motion of the information handling system is greater than the linear motion threshold, and in response, adjusting the magnetic force of the electromagnet to retain the closed state of the information handling system.

5. The method of claim 1, further comprising:
determining that i) the tilt of the information handling system is less than the tilt threshold and ii) the linear motion of the information handling system is less than the linear motion threshold, and in response, decreasing the magnetic force of the electromagnet.

6. The method of claim 2, further comprising:
determining that the angle is greater than zero degrees, and in response, decreasing the magnetic force of the electromagnet.

7. The method of claim 1, wherein the tilt threshold is approximately 70 degrees.

8. An information handling system, comprising:
a plurality of sensors to provide sensor data associated with the information handling system;
an electromagnet;
a processor;
memory media storing instructions executable by the processor to perform operations;
determining, based on the sensor data, that the information handling system is in a closed state;
in response to determining that the information handling system is in the closed state:
calculating, based on the sensor data, a tilt of the information handling system;
calculating, based on the sensor data, linear motion of the information handling system;
determining whether the tilt of the information handling system is greater than a tilt threshold and determining whether the linear motion of the information handling system is greater than a linear motion threshold; and
in response to determining that at least one of i) the tilt of the information handling system being greater than the tilt threshold and ii) the linear motion of the information handling system being greater than the linear motion threshold:
adjusting a magnetic force of the electromagnet to retain the closed state of the information handling system.

9. The information handling system of claim 8, wherein determining that the information handling system is in the closed state further includes:
calculating an angle between a first body and a second body of the information handling system; and
determining that the angle is zero degrees indicating the closed state of the information handling system.

10. The information handling system of claim 8, wherein adjusting the magnetic force of the electromagnetic further includes adjusting an electric current at the electromagnet.

11. The information handling system of claim 8, the operations further comprising:
determining that both i) the tilt of the information handling system is greater than the tilt threshold and ii) the linear motion of the information handling system is greater than the linear motion threshold, and in response, adjusting the magnetic force of the electromagnet to retain the closed state of the information handling system.

12. The information handling system of claim 8, the operations further comprising:
determining that i) the tilt of the information handling system is less than the tilt threshold and ii) the linear motion of the information handling system is less than the linear motion threshold, and in response, decreasing the magnetic force of the electromagnet.

13. The information handling system of claim 9, the operations further comprising:
determining that the angle is greater than zero degrees, and in response, decreasing the magnetic force of the electromagnet.

14. The information handling system of claim 8, wherein the tilt threshold is approximately 70 degrees.

15. A non-transitory computer-readable medium storing software comprising instructions executable by one or more computers which, upon such execution, cause the one or more computers to perform operations comprising:
determining that the information handling system is in a closed state;
in response to determining that the information handling system is in the closed state:
calculating a tilt of the information handling system;
calculating linear motion of the information handling system;
determining whether the tilt of the information handling system is greater than a tilt threshold and determining whether the linear motion of the information handling system is greater than a linear motion threshold; and
in response to determining that at least one of i) the tilt of the information handling system being greater than the tilt threshold and ii) the linear motion of the information handling system being greater than the linear motion threshold:
adjusting a magnetic force of an electromagnet to retain the closed state of the information handling system.

16. The computer-readable medium of claim 15, wherein determining that the information handling system is in the closed state further includes:
calculating an angle between a first body and a second body of the information handling system; and
determining that the angle is zero degrees indicating the closed state of the information handling system.

17. The computer-readable medium of claim 15, wherein adjusting the magnetic force of the electromagnetic further includes adjusting an electric current at the electromagnet.

18. The computer-readable medium of claim 15, the operations further comprising:
determining that both i) the tilt of the information handling system is greater than the tilt threshold and ii) the linear motion of the information handling system is greater than the linear motion threshold, and in response, adjusting the magnetic force of the electromagnet to retain the closed state of the information handling system.

19. The computer-readable medium of claim 15, the operations further comprising:
determining that i) the tilt of the information handling system is less than the tilt threshold and ii) the linear motion of the information handling system is less than the linear motion threshold, and in response, decreasing the magnetic force of the electromagnet.

20. The computer-readable medium of claim 16, the operations further comprising:
determining that the angle is greater than zero degrees, and in response, decreasing the magnetic force of the electromagnet.
